(19) United States
(12) Patent Application Publication
(10) Pub. No.: US 2025/0360934 A1
(43) Pub. Date: Nov. 27, 2025

(54) VEHICLE CONTROL DEVICE AND METHOD, AND VEHICLE SYSTEM INCLUDING THE SAME

(71) Applicants: HYUNDAI MOTOR COMPANY, SEOUL (KR); KIA CORPORATION, SEOUL (KR)

(72) Inventor: Joo Beom Kim, Hwaseong-si (KR)

(73) Assignees: HYUNDAI MOTOR COMPANY, SEOUL (KR); KIA CORPORATION, SEOUL (KR)

(21) Appl. No.: 18/924,186

(22) Filed: Oct. 23, 2024

(30) Foreign Application Priority Data
May 21, 2024 (KR) 10-2024-0065734

(51) Int. Cl. B60W 50/02; B60W 10/04; B60W 10/18

(52) U.S. Cl. CPC B60W 50/0225; B60W 10/04; B60W 10/18; B60W 50/0205; B60W 2510/18; B60W 2520/10; B60W 2520/105; B60W 2520/28; B60W 2540/225

(57) ABSTRACT

A vehicle control device includes a memory storing computer-executable instructions and a processor configured to access the memory and execute the instructions. The instructions include, determining whether a driving controller and a braking controller of a vehicle are abnormal when a minimum risk maneuver (MRM) mode operates, deriving a required deceleration and actual deceleration of the vehicle using one or more sensors installed in the vehicle, determining whether acceleration override has occurred based on the required deceleration and the actual deceleration, and determining a driving control subject of the vehicle based on a result of determining whether the acceleration override has occurred.

### CROSS REFERENCE TO RELATED APPLICATIONS

This application claims benefit of priority to Korean Patent Application No. 10-2024-0065734 filed on May 21, 2024 in the Korean Intellectual Property Office, the disclosure of which is incorporated herein by reference in its entirety.

### BACKGROUND

### 1. Field

The present disclosure relates to a vehicle control device and method, and a vehicle system including the same.

### 2. Description of Related Art

An autonomous driving system performs a minimum risk maneuver (MRM) mode when a main controller or mechanism of a vehicle fails while an autonomous driving function is operating. In addition, if a driver does not take over a control right for a certain period of time after a control right transfer request is output to the driver, the MRM mode is automatically performed.

During MRM performance, a driving controller operates according to a control signal from an autonomous driving controller, and acceleration override should be prohibited even if there is an acceleration signal input from the driver.

However, if a communication error occurs in the driving controller, a situation in which the driving controller cannot receive signals from the autonomous driving controller may occur, and in this situation, if the driver has a desire to drive, there is a need to allow acceleration override according to an acceleration signal input from the driver.

In particular, when the MRM is activated due to a communication failure of the driving controller, an acceleration signal may be input from the driver at the same time while deceleration control is performed for deceleration and stopping, which is the goal of the MRM itself. In this case, acceleration and deceleration occur simultaneously in the vehicle, leading to a problem in that it is impossible to release the MRM by decelerating or stopping.

### SUMMARY

An aspect of the present disclosure is to provide a vehicle control device and method capable of improving driving safety, and a vehicle system including the same.

Another aspect of the present disclosure is to provide a vehicle control device and method capable of determining whether a communication failure of a driving controller has occurred and whether a braking controller is normal when operating in a minimum risk maneuver (MRM) mode, determining acceleration override based on a required deceleration and actual deceleration of the vehicle, and rapidly determining an appropriate driving control subject of a vehicle, and a vehicle system including the same.

In order to achieve the above objects, the present disclosure provides a vehicle control device and method, and a vehicle system including the same.

According to an aspect of the present disclosure, a vehicle control device includes a storage medium configured to store an instruction executable by the processor, wherein the processor is configured to, by executing the instruction, determine whether a driving controller and a braking controller of a vehicle are abnormal when a minimum risk maneuver (MRM) mode operates, derive a required deceleration and actual deceleration of the vehicle using one or more sensors installed in the vehicle, determine whether acceleration override has occurred based on the required deceleration and the actual deceleration, and determine a driving control subject of the vehicle based on a result of determining whether the acceleration override has occurred.

According to another aspect of the present disclosure, a vehicle control method performed by a computing device including a processor and a storage medium configured to store an instruction executable by the processor includes determining whether a driving controller and a braking controller of a vehicle are abnormal when a minimum risk maneuver (MRM) mode operates, deriving a required deceleration and actual deceleration of the vehicle using one or more sensors installed in the vehicle, determining whether acceleration override has occurred based on the required deceleration and the actual deceleration, and determining a driving control subject of the vehicle based on a result of determining whether the acceleration override has occurred.

According to another aspect of the present disclosure, a vehicle system includes one or more sensors, and a vehicle control device configured to determine whether a driving controller and a braking controller are abnormal when a minimum risk maneuver (MRM) mode operates, derive a required deceleration and actual deceleration using one or more sensors, determine whether acceleration override has occurred based on the required deceleration and the actual deceleration, and determine a driving control subject of a vehicle based on a result of determining whether the acceleration override has occurred.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a block diagram of a vehicle including a vehicle control device according to an embodiment of the present disclosure;

FIG. 2 is a flowchart of a vehicle control method according to an embodiment of the present disclosure;

FIG. 3A is a detailed flowchart of a vehicle control method according to an embodiment of the present disclosure;

FIG. 3B is a graph illustrating a vehicle control method according to an embodiment of the present disclosure;

FIG. 4 is a detailed flowchart of a vehicle control method according to an embodiment of the present disclosure;

FIG. 5 is a flowchart of a vehicle control method according to another embodiment of the present disclosure; and

FIG. 6 is a block diagram of a computing device that may fully or partially implement a vehicle control device according to an embodiment of the present disclosure.

### DETAILED DESCRIPTION

Hereinafter, embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure.

In the following description of the present disclosure, a detailed description of known functions and configurations incorporated herein will be omitted when it would render the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

It will be understood that when an element is referred to as being “connected to” another element, it may be directly connected to the other element or intervening elements may also be present. In contrast, when an element is referred to as being “directly connected to” another element, no intervening elements are present.

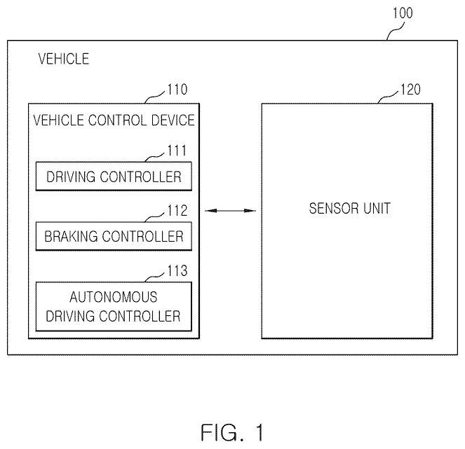

FIG. 1 schematically illustrates a vehicle including a vehicle control device according to an embodiment of the present disclosure. Referring to FIG. 1, a vehicle 100 may include a vehicle control device 110 and a sensor unit 120.

The vehicle 100 may be controlled by a vehicle operation signal input by a driver or may be controlled by an autonomous driving function of the vehicle 100.

The vehicle control device 110 may control various components required to control starting, power, braking, steering, and shifting of the vehicle 100.

The vehicle control device 110 may generate a signal for controlling the vehicle 100. The vehicle control device 110 may transmit the generated control signal to other components of the vehicle 100 through a controller area network (CAN) signal.

As illustrated in FIG. 1, the vehicle control device 110 may include a driving controller 111 controlling a driving mechanism, a braking controller 112 controlling a braking mechanism, and an autonomous driving controller 113.

For example, the driving controller 111 may adjust a driving speed of the vehicle 100 by controlling the driving mechanism including a front wheel motor and a rear wheel motor of the vehicle 100 based on a signal from an accelerator position sensor (APS) input by the driver.

In addition, the braking controller 112 may reduce or stop the driving speed of the vehicle 100 by controlling the braking mechanism of the vehicle 100 based on a signal from a brake pedal sensor (BPS).

The autonomous driving controller 113 may generate a control signal for autonomous driving of the vehicle and transmit a signal for controlling the driving of the vehicle to the driving controller 111 or the braking controller 112.

The vehicle control device 110 may further include a storage unit and a communication unit. The storage unit may store various programs and data for implementing functions performed by the driving controller 111, the braking controller 112, and the autonomous driving controller 113. The communication unit may be used to enable the driving controller 111, the braking controller 112, and the autonomous driving controller 113 to transmit and receive data with each other or with other components of the vehicle 100.

The sensor unit 120 may include one or more sensors collecting information related to the vehicle 100. The sensor unit 120 may include, for example, at least one of a wheel speed sensor, a vehicle speed sensor detecting a speed of the vehicle 100, an accelerator pedal position sensor linked to an operation of an accelerator pedal, a brake pedal sensor linked to an operation of a brake pedal, a steering angle sensor (SAS) linked to an operation of a steering wheel, an external monitoring sensor collecting information on a surrounding situation of the vehicle 100, a driver monitoring sensor collecting driver status information, and an internal monitoring sensor collecting information on an internal environment of the vehicle 100.

The sensor unit 120 may transmit the collected information related to the vehicle 100 to the vehicle control device 110 through a CAN signal.

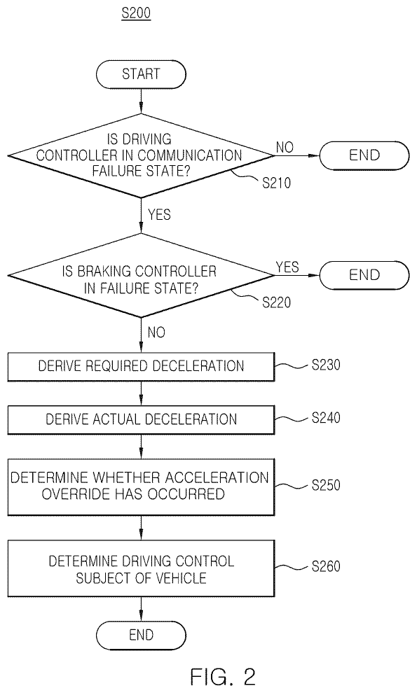

FIG. 2 is a flowchart of a vehicle control method according to an embodiment of the present disclosure. The vehicle control method illustrated in FIG. 2 may be fully or partially performed by the autonomous driving controller 113 included in the vehicle control device 110 illustrated in FIG. 1.

A vehicle control method (S200) of the present disclosure is for determining a driving control subject at the time of acceleration override when the MRM mode is activated due to a communication failure of a driving controller. The vehicle control method (S200) is to release the MRM mode and transfer a driving control right to the driver or to maintain the MRM mode when acceleration override is determined.

Specifically, as illustrated in FIG. 2, the vehicle control method (S200) may include determining a communication failure of the driving controller (S210), determining a failure of a braking controller (S220), deriving a required deceleration based on information on a surrounding situation of a vehicle (S230), deriving an actual deceleration of the vehicle while deceleration control is performed based on the required deceleration (S240), determining whether acceleration override has occurred (S250), and determining a driving control subject of the vehicle (S260).

The vehicle control method (S200) determines whether a driving controller and a braking controller of the vehicle are abnormal when operating an MRM mode, and determine whether to perform acceleration override in a subsequent operation when the driving controller is determined to be in a communication failure state and the braking controller is determined to be in a normal state according to a determination result.

The determining of a communication failure of the driving controller (S210) may include periodically transmitting a first message to the driving controller and determining whether a response message on the first message is received from the driving controller. The first message and the response message on the first message may be transmitted and received using a CAN signal.

For example, if the response message on the first message is not received from the driving controller in S210, it may be determined that the driving controller is in a communication failure state.

Referring to FIG. 2, if it is determined in S210 that the driving controller is in a communication failure state, the vehicle control method (S200) may proceed to S220.

Meanwhile, if it is determined in S210 that the driving controller is not in a communication failure state, the vehicle control method (S200) may be terminated.

If it is determined in S220 that the brake controller is not in a failure state, that is, in a normal state, the vehicle control method (S200) may proceed to S230.

Meanwhile, if it is determined in S220 that the braking controller is in a failure state, the vehicle control method (S200) may be terminated.

The deriving of the required deceleration based on the information on the surrounding situation of the vehicle (S230) may include receiving the information on the surrounding situation of the vehicle from one or more sensors and deriving the required deceleration of the vehicle based on the information on the surrounding situation of the vehicle.

For example, the one or more sensors are external monitoring sensors collecting the information on the surrounding situation of the vehicle and may include at least one of a camera, an infrared sensor, a radar sensor, and a lidar sensor.

The deriving of the actual deceleration of the vehicle while deceleration control based on the required deceleration is performed (S240) may include transmitting the required deceleration derived in S230 to the brake controller, receiving wheel speed information of the vehicle measured using a wheel speed sensor while deceleration control based on the required deceleration is performed, deriving a speed of the vehicle from the wheel speed information of the vehicle, and deriving an actual deceleration of the vehicle based on the speed of the vehicle.

In the determining of whether acceleration override has occurred (S250), whether acceleration override has occurred may be determined based on the required deceleration of the vehicle derived in S230 and the actual deceleration of the vehicle derived in S240.

In the determining of whether acceleration override has occurred (S250), a determination section including a first point in time at which a difference between the required deceleration and the actual deceleration is greater than or equal to a reference value may be detected.

In the determining of whether acceleration override has occurred (S250), it may be determined that the determination section starts from the first point in time at which the difference between the required deceleration and the actual deceleration is greater than or equal to the reference value.

The reference value may be set based on a deceleration value of the vehicle that may be interpreted as a situation in which the driver inputs an accelerator pedal despite deceleration control. The reference value may be set such that the actual deceleration compared to the required deceleration has a difference in a positive (+) direction (an acceleration direction).

In addition, in the detecting of the determination section, if the difference between the required deceleration and the actual deceleration after the first point in time has a value outside a buffer range, it may be determined that the determination section terminates.

For example, although there is a first section in which the difference between the required deceleration and the actual deceleration is less than or equal to the reference value after the first point in time, if the difference between the reference value and the actual deceleration in the first section is within a buffer difference range, it may be determined that the determination section does not terminate.

For another example, although there is a second section in which the difference between the required deceleration and the actual deceleration is less than or equal to the reference value after the first point in time, if a maintenance time of the second section is within a buffer time range, it may be determined that the determination section does not terminate.

In the determining of whether acceleration override has occurred (S250), whether acceleration override has occurred may be determined based on whether the maintenance time of the determination section is greater than or equal to the reference time.

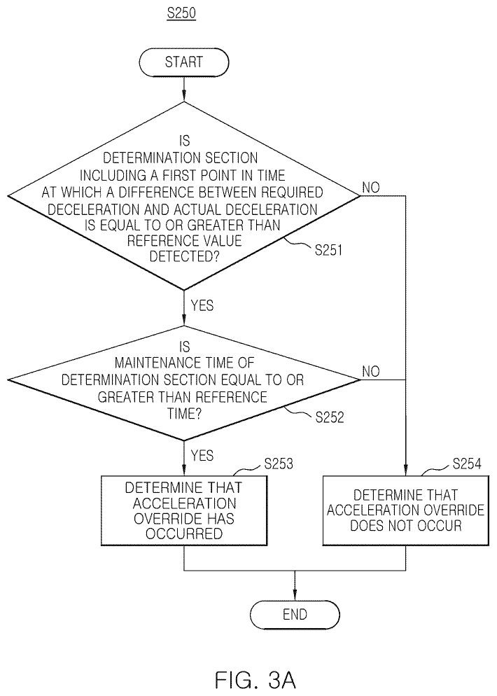

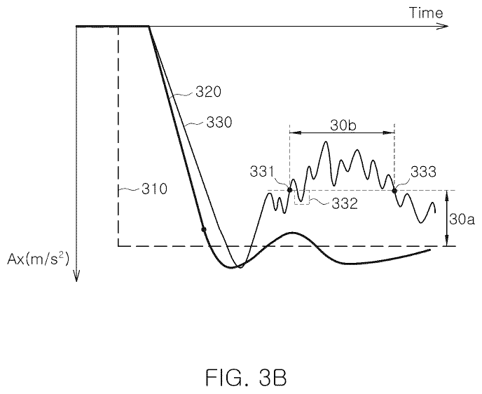

FIG. 3A illustrates a detailed flowchart of the operation (S250) of determining whether acceleration override has occurred included in the vehicle control method (S200).

As illustrated in FIG. 3A, in the determining of whether acceleration override has occurred (S250), when the determination section including the first point in time at which the difference between the required deceleration and the actual deceleration is greater than or equal to the reference value is detected in S251, the process may proceed to operation S252.

Meanwhile, if the determination section including the first point in time at which the difference between the required deceleration and the actual deceleration is greater than or equal to the reference value is not detected in S251, the process may proceed to operation (S254) of determining that acceleration override does not occur (S254).

If the maintenance time of the determination section in S252 is greater than or equal to the reference time, the process may proceed to determining that acceleration override has occurred (S253).

Meanwhile, if the maintenance time of the determination section in S252 is not greater than the reference time, the process may proceed to the operation (S254) of determining that acceleration override does not occur (S254).

Referring to FIG. 3B, a required deceleration graph 310 of the vehicle a first actual deceleration graph 320 of the vehicle, and a second actual deceleration graph 330 of the vehicle over time are illustrated as examples.

Based on the information on the surrounding situation of the vehicle, required deceleration information, such as the required deceleration graph 310 of the vehicle may be derived. When the required deceleration information is transmitted to the brake controller, deceleration control based on the required deceleration may be performed by the brake controller controlling the braking mechanism of the vehicle.

When deceleration control based on the required deceleration is normally performed, the actual deceleration of the vehicle may appear as illustrated in the first actual deceleration graph 320. The first actual deceleration graph 320 does not have a section in which the difference between the required deceleration of the vehicle and the actual deceleration is greater than or equal to a reference value 30a.

Meanwhile, if acceleration override has occurred while deceleration control based on the required deceleration is performed, the actual deceleration of the vehicle may appear like the second actual deceleration graph 330.

The second actual deceleration graph 330 may have a first point in time 331 at which the difference between the required deceleration of the vehicle and the actual deceleration is greater than or equal to the reference value 30a. In the second actual deceleration graph 330, a determination section 30b for determining whether acceleration override has occurred may be detected from a first point in time 331.

Although there is a section 332 in which the difference between the required deceleration and the actual deceleration is less than or equal to the reference value after the first point in time 331, if the difference between the reference value 30a and the actual deceleration in the section 332 is within the buffer difference range of if the maintenance time of the section 332 is within the buffer time range, it may be determined that the determination section 30b does not terminate.

Subsequently, if the difference between the required deceleration and the actual deceleration has a value outside the buffer range after the first point in time 331, it may be determined that the determination section 30b terminates.

In the determining of the driving control subject of the vehicle (S260), the MRM mode may be released based on the result of determining whether acceleration override has occurred, and a driving control right may be transferred to the driver or the MRM mode may be maintained.

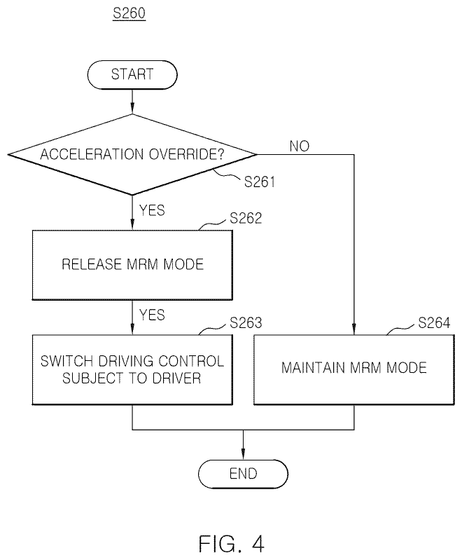

FIG. 4 illustrates a detailed flowchart of the operation (S260) of determining a driving control subject of a vehicle included in the vehicle control method (S200).

Referring to FIG. 4, in the determining of the driving control subject of the vehicle (S260), when it is determined that acceleration override has occurred in S261, the process may proceed to operation (S262) of releasing the MRM mode and operation (S263) of changing the driving control subject to the driver.

Meanwhile, if it is determined in S261 that acceleration override does not occur, the process may proceed to operation (s264) of maintaining the MRM mode.

In the vehicle control method (S200) according to an embodiment of the present disclosure, although the MRM mode operates due to a communication failure of the driving controller, it is determined whether the driver intends to drive manually from the actual deceleration information of the vehicle, and if it is determined that the driver intends to drive manually, the driving control right may be rapidly transferred to the driver, thereby improving driving safety.

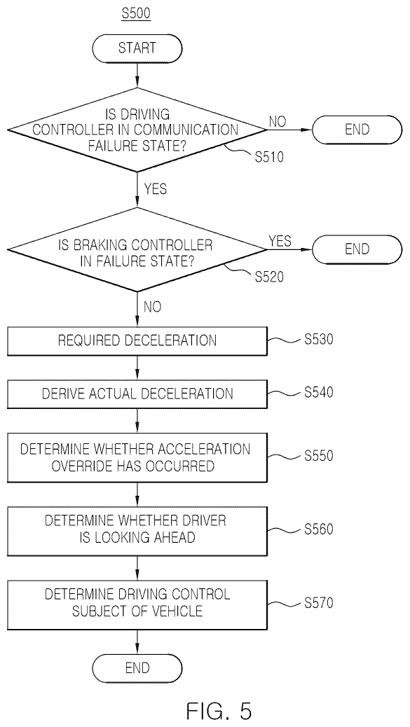

FIG. 5 is a flowchart of a vehicle control method according to another embodiment of the present disclosure. The vehicle control method illustrated in FIG. 5 may be fully or partially performed by the vehicle control device 110 illustrated in FIG. 1.

Referring to FIG. 5, a vehicle control method (S500) may include determining a communication failure of the driving controller (S510), determining whether a braking controller has experienced a failure (S520), deriving a required deceleration based on information on a surrounding situation of the vehicle (S530), deriving an actual deceleration of the vehicle while deceleration control based on the required deceleration is performed (S540), determining whether acceleration override has occurred (S550), and determining whether the driver is looking ahead (S560), and determining a driving control subject of the vehicle (S570).

S510 to S550 included in the vehicle control method (S500) may be performed in the same or similar manner as the operations included in the vehicle control method (S200) described above with reference to FIGS. 2 to 4. The vehicle control method (S500) may further include the operation (S560) of determining whether the driver is looking ahead.

The determining (S560) of whether the driver is looking ahead may include receiving driver monitoring information measured using a driver monitoring sensor and determining whether the driver is looking ahead based on the driver monitoring information.

In the determining of the driving control subject of the vehicle (S570), the driving control subject may be determined based on whether the acceleration override has occurred, which is determined in S550, and whether the driver is looking ahead, which is determined in S560.

For example, in the determining of the driving control subject of the vehicle (S570), when it is determined that acceleration override has occurred in S550 and the driver is looking ahead in S560, the MRM mode may be released and the driving control subject of the vehicle may be switched to the driver.

The vehicle control method (S500) may more robustly determine the presence or absence of the driver's desire to drive manually by determining the driving control subject of the vehicle based on whether the driver is looking ahead.

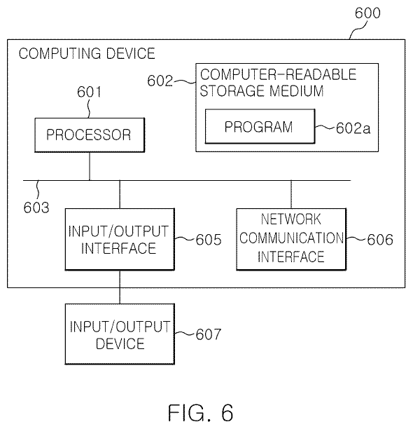

FIG. 6 is a block diagram of a computing device 600 capable of fully or partially implementing a vehicle control device according to an embodiment of the present disclosure, which may be the vehicle control device 110 illustrated in FIG. 1.

As illustrated in FIG. 6, the computing device 600 includes at least one processor 601, computer-readable storage medium 602, and a communication bus 603.

The processor 601 may enable the computing device 600 to operate according to the embodiments mentioned above. For example, the processor 601 may execute one or more programs stored in the computer-readable storage medium 602. The one or more programs may include one or more computer-executable instructions, which, when executed by the processor 601, may cause the computing device 600 to perform operations according to embodiments.

The computer-readable storage medium 602 is configured to store computer-executable instructions or program code, program data, and/or other suitable form of information. A program 602a stored in the computer-readable storage medium 602 includes a set of instructions executable by the processor 601. In an embodiment, the computer-readable storage medium 602 may include memory (volatile memory, such as random access memory, non-volatile memory, or appropriate combinations thereof), one or more magnetic disk storage devices, optical disk storage devices, flash memory devices, another form of storage medium that may be accessed by the computing device 600 and store desired information, or appropriate combinations thereof.

The communication bus 603 interconnects various other components of the computing device 600 including the processor 601 and the computer-readable storage medium 602.

The computing device 600 may include one or more input/output interfaces 605 providing an interface for one or more input/output devices 604 and one or more network communication interfaces 606. The input/output interface 605 and the network communication interface 606 are connected to the communication bus 603.

The network communication interface 606 is an interface for communication within the vehicle or an interface for communication between the vehicle and other devices other than the vehicle and may include, for example, a controller area network (CAN), media oriented systems transport (MOST) network, local interconnect network (LIN) and/or X-by-Wire (Flexray), Wi-Fi, Bluetooth, NFC, RFID, etc. The network may be a cellular network, such as global system for mobile communications (GSM), enhanced data rates for GSM Evolution (EDGE), general packet radio service (GPRS), code division multiple access (CDMA), and time division-CDMA (TD-CDMA), universal mobile telecommunications system (UMTS), long term evolution (LTE), or other cellular networks.

The input/output device 604 may be connected to other components of computing device 600 through the input/output interface 605. For example, the input/output device 604 may include, but is not limited to, a pointing device (such as a mouse or trackpad), a keyboard, a touch input device (such as a touchpad or touch screen), a voice or sound input device, various types of sensor devices, and/or input devices, such as imaging devices, and output devices, such as display devices, printers, speakers, and/or network cards. The input/output device 604 may be a component constituting the computing device 600 and may be included within the computing device 600 or may be connected to the computing device 600 as a separate device distinct from the computing device 600.

The present disclosure may provide the vehicle control device and method capable of improving driving safety and the vehicle system including the same.

In an embodiment, the present disclosure may provide the vehicle control device and method capable of determining whether a communication failure of a driving controller has occurred and whether a braking controller is normal when operating in a minimum risk maneuver (MRM) mode, determining acceleration override based on a required deceleration and actual deceleration of the vehicle, and rapidly determining an appropriate driving control subject of a vehicle, and the vehicle system including the same.

In addition, the present disclosure may improve the stability of the vehicle system without changing the manufacturing costs or weight by utilizing a brake redundancy system (IEB/RCU) control interface that was previously installed in the vehicle.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

While the present disclosure has been particularly illustrated and described with reference to embodiments thereof, a person skilled in the art will understand that the invention is not limited to the disclosed embodiments but may be variously modified within the scope of the present disclosure. Therefore, the scope of the present disclosure should not be limited to the above-described embodiments but should be determined by all changes or modifications derived from the scope of the appended claims and equivalents of the following claims.

While example embodiments have been illustrated and described above, it will be apparent to those skilled in the art that modifications and variations could be made without departing from the scope of the present disclosure as defined by the appended claims.

1. A vehicle control device comprising:
a memory storing computer-executable instructions; and
a processor configured to access the memory and execute the instructions, wherein the instructions comprise:
determining whether a driving controller and a braking controller of a vehicle are abnormal when a minimum risk maneuver (MRM) mode operates;
deriving a required deceleration and actual deceleration of the vehicle using one or more sensors installed in the vehicle;
determining whether acceleration override has occurred based on the required deceleration and the actual deceleration; and
determining a driving control subject of the vehicle based on a result of determining whether the acceleration override has occurred.

2. The vehicle control device of claim 1, wherein the instructions further comprise determining whether the acceleration override has occurred when it is determined that the driving controller is in a communication failure state and the braking controller is in a normal state during the MRM mode.

3. The vehicle control device of claim 2, wherein the instructions further comprise:
periodically transmitting a first message to the driving controller; and
determining that the driving controller is in a communication failure state when a response message on the first message is not received from the driving controller.

4. The vehicle control device of claim 1, wherein the instructions further comprise:
receiving information on a surrounding situation of the vehicle from the one or more sensors; and
deriving the required deceleration based on the information on the surrounding situation of the vehicle.

5. The vehicle control device of claim 4, wherein the one or more sensors include a wheel speed sensor, and wherein the instructions further comprise:
transmitting the required deceleration to the braking controller;
deriving a speed of the vehicle from wheel speed information of the vehicle measured using the wheel speed sensor, while deceleration control based on the required deceleration is performed; and
deriving the actual deceleration of the vehicle based on the speed of the vehicle.

6. The vehicle control device of claim 1, wherein the instructions further comprise:
detecting a determination section including a first point in time at which a difference between the required deceleration and the actual deceleration is greater than or equal to a reference value; and
determining whether the acceleration override has occurred based on whether a maintenance time of the determination section is greater than or equal to a reference time.

7. The vehicle control device of claim 6, wherein the instructions further comprise determining that the determination section terminates when the difference between the required deceleration and the actual deceleration after the first point in time has a value outside a buffer range.

8. The vehicle control device of claim 6, wherein the instructions further comprise:
determining that acceleration override has occurred when the maintenance time of the determination section is greater than or equal to the reference time; and
releasing the MRM mode and determining the driving control subject to be a driver when it is determined that acceleration override has occurred.

9. The vehicle control device of claim 1, wherein the one or more sensors include a driver monitoring sensor, and wherein the instructions further comprise:
determining whether a driver is looking ahead based on driver monitoring information measured using the driver monitoring sensor; and
determining the driving control subject to be the driver when it is determined that the driver is looking ahead.

10. A vehicle control method performed by a computing device including a processor and a memory storing computer-executable instructions, the vehicle control method comprising:
determining whether a driving controller and a braking controller of a vehicle are abnormal when a minimum risk maneuver (MRM) mode operates;
deriving a required deceleration and actual deceleration of the vehicle using one or more sensors installed in the vehicle;
determining whether acceleration override has occurred based on the required deceleration and the actual deceleration; and
determining a driving control subject of the vehicle based on a result of determining whether the acceleration override has occurred.

11. The vehicle control method of claim 10, wherein the determining of whether there is an abnormality in the driving controller and the braking controller of the vehicle includes:
determining whether the driving controller is in a communication failure state; and
determining whether the braking controller is in a normal state.

12. The vehicle control method of claim 11, wherein the determining of whether the driving controller is in a communication failure state includes:
periodically transmitting a first message to the driving controller; and
determining whether a response message on the first message is received from the driving controller;
wherein it is determined that the driving controller is in a communication failure state when a response message on the first message is not received from the driving controller.

13. The vehicle control method of claim 10, wherein the deriving of the required deceleration and actual deceleration of the vehicle includes:
receiving information on a surrounding situation of the vehicle from the one or more sensors; and
deriving the required deceleration based on the information on the surrounding situation of the vehicle.

14. The vehicle control method of claim 13, wherein the one or more sensors include a wheel speed sensor, and the deriving of the required deceleration and actual deceleration of the vehicle further includes:
transmitting the required deceleration to the braking controller;
receiving wheel speed information of the vehicle measured using the wheel speed sensor while deceleration control based on the required deceleration is performed;
deriving a speed of the vehicle from the wheel speed information of the vehicle; and
deriving the actual deceleration of the vehicle based on the speed of the vehicle.

15. The vehicle control method of claim 10, wherein the determining of whether acceleration override has occurred includes:
detecting a determination section including a first point in time at which a difference between the required deceleration and the actual deceleration is greater than or equal to a reference value; and
determining whether the acceleration override has occurred based on whether a maintenance time of the determination section is greater than or equal to a reference time.

16. The vehicle control method of claim 15, wherein the detecting of the determination section includes determining that the determination section terminates when the difference between the required deceleration and the actual deceleration after the first point in time has a value outside a buffer range.

17. The vehicle control method of claim 15, wherein, in the determining of whether the acceleration override has occurred, when the maintenance time of the determination section is greater than or equal to the reference time, it is determined that acceleration override has occurred, and
in the determining of the driving control subject of the vehicle, when it is determined that acceleration override has occurred, the MRM mode is released and the driving control subject is determined to be a driver.

18. The vehicle control method of claim 10, wherein the one or more sensors include a driver monitoring sensor, and wherein the vehicle control method further includes:
receiving driver monitoring information measured using the driver monitoring sensor; and
determining whether a driver is looking ahead based on the driver monitoring information; and
in the determining of the driving control subject of the vehicle, the driving control subject is determined based on whether the driver is looking ahead.

19. A vehicle system comprising:
one or more sensors; and
a vehicle control device configured to:
determine whether a driving controller and a braking controller are abnormal when a minimum risk maneuver (MRM) mode operates;
derive a required deceleration and actual deceleration using one or more sensors;
determine whether acceleration override has occurred based on the required deceleration and the actual deceleration; and
determine a driving control subject of a vehicle based on a result of determining whether the acceleration override has occurred.

20. The vehicle system of claim 19, wherein the vehicle control device is configured to determine whether acceleration override has occurred when the driving controller is in a communication failure state and the braking controller is determined to be in a normal state during the MRM mode.
